(19) United States
(12) Patent Application Publication
(10) Pub. No.: US 2023/0419745 A1
(43) Pub. Date: Dec. 28, 2023

(54) SYSTEMS AND TECHNIQUES FOR PROVIDING AN ADAPTABLE AND CONTAINER-BASED INTERNET OF THINGS PLATFORM ENVIRONMENT

(71) Applicant: THE MOREY CORPORATION, Woodridge, IL (US)

(72) Inventors: Michael MORAN, Woodridge, IL (US); John KULPINSKI, Woodridge, IL (US)

(21) Appl. No.: 18/188,595

(22) Filed: Mar. 23, 2023

Related U.S. Application Data
(60) Provisional application No. 63/354,951, filed on Jun. 23, 2022.

(51) Int. Cl. G07C 5/00; G16Y 10/40

(52) U.S. Cl. CPC G07C 5/008; G16Y 10/40

(57) ABSTRACT

Systems and techniques are disclosed for providing an adaptable Internet of Things platform. A platform edge gateway device hosts containerized applications, in which each containerized application performs a discrete function. The edge gateway device correlates data output from one or more of the containerized applications, which are then transmitted to additional containerized applications for further processing.

### CROSS-REFERENCE TO RELATED APPLICATIONS

This application claims the benefit of priority from U.S. Provisional Application No. 63/354,951, filed Jun. 23, 2022, the disclosure of which is hereby incorporated by reference herein in its entirety.

### FIELD

The present disclosure is generally directed to Internet of Things (IoT), and more specifically, to systems and techniques for providing an IoT platform hosting container-based applications for adaptability.

### BACKGROUND

Internet of Things (IoT) technology may be applied to a variety of settings. For example, in the vehicle fleet space, vehicles may incorporate IoT services to enhance fleet operations, such as in telematics, road condition monitoring, and emergency services. The technology uses edge computing to process data at a location in closer network proximity to the vehicle, as opposed to a centralized location such as in a cloud network. Doing so ensures that backend application processes receive critical input data relatively quickly.

However, current techniques may suffer from drawbacks related to latency and difficulty developing desired services tailored for a given use. For example, while edge computing provides relatively quick access to IoT services provided over an edge network, it may be preferable to have some services and backend processes be more readily accessible. As another example, implementing features in a setting, such as the vehicle space, often requires a developer to write low-level code to communicate with the underlying vehicle systems and sensors. Because of the complexity of such code, this approach can serve as a barrier to creative and innovative developments and can also be error prone.

### SUMMARY

Embodiments presented herein disclose a system and techniques for providing an adaptable IoT platform having an edge device hosting container-based applications.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a conceptual diagram of an example computing environment having an adaptable Internet of Things (IoT) platform, according to an embodiment;

FIG. 2 is a conceptual block diagram of an example edge gateway device of FIG. 1, according to an embodiment;

FIG. 3 is a conceptual diagram of the software layer of the edge gateway device of FIG. 1, according to an embodiment;

FIG. 4 is a block diagram illustrating further hardware components of the edge gateway device of FIG. 1, according to an embodiment;

FIG. 5 is a conceptual diagram illustrating an example of adapting the IoT platform of FIG. 1 to a vehicle telematics environment, according to an embodiment;

FIG. 6 is a conceptual diagram illustrating an example of adapting the IoT platform of FIG. 1 to a smart commercial heavy duty vehicle, according to an embodiment;

FIG. 7 is a flow diagram illustrating an example method flow for managing containerized applications within an adaptable IoT platform, according to an embodiment;

FIG. 8 is a flow diagram illustrating an example method flow for programming customizable rules to a rules engine within an adaptable IoT platform, according to an embodiment; and

FIG. 9 is a flow diagram illustrating an example method flow for controlling functions within an IoT platform based on a set of middleware functions, according to an embodiment.

### DETAILED DESCRIPTION

Embodiments presented herein disclose systems and techniques for providing an Internet of Things (IoT) platform adaptable to a variety of settings. Specifically, the IoT platform includes an edge gateway device that serves as an application hub that may be adapted to a variety of settings, such as in the vehicle space, industrial automation, oil and gas, and so on. Further, to provide such adaptability, as further described herein, the IoT platform may include a middleware application programming interface (API) customized to a given setting, which allows a developer to create and deploy applications using relatively simple functions, e.g., to achieve closed loop control within the setting. More particularly, the middleware API may provide a library of helper functions to communicate and/or control any underlying hardware and drivers associated with the setting. As a result, the developer may use such functions to access the hardware and drivers without needing to write complex code to the drivers.

As also further described herein, the IoT platform also provides adaptability using containerization (e.g., via Docker), through which the edge gateway device acts as an application hub and performs desired functionality (e.g., vehicle telematics, health readiness, tracking, etc.) within user space. Containerization allows the edge gateway device to execute desired functions via discrete applications, in which a given application may implement a given feature, such as vehicle telematics, health readiness, or analytics, in a container-based application. The IoT platform may provide the container-based applications for download by a user (e.g., a fleet operator, manufacturer, end user, etc.) over a network. In addition, the IoT platform may allow a user to customize which of those applications to download, install, and execute on the edge gateway device, which provides flexibility for a user to configure the edge gateway device for lightweight or resource-intensive performance. Such customization also allows the edge gateway device to obtain and correlate data from a variety of functions, such as vehicle telematics, video capture, and health readiness, to provide further utility to the user (predictive analytics, safety alerts and controls, etc.).

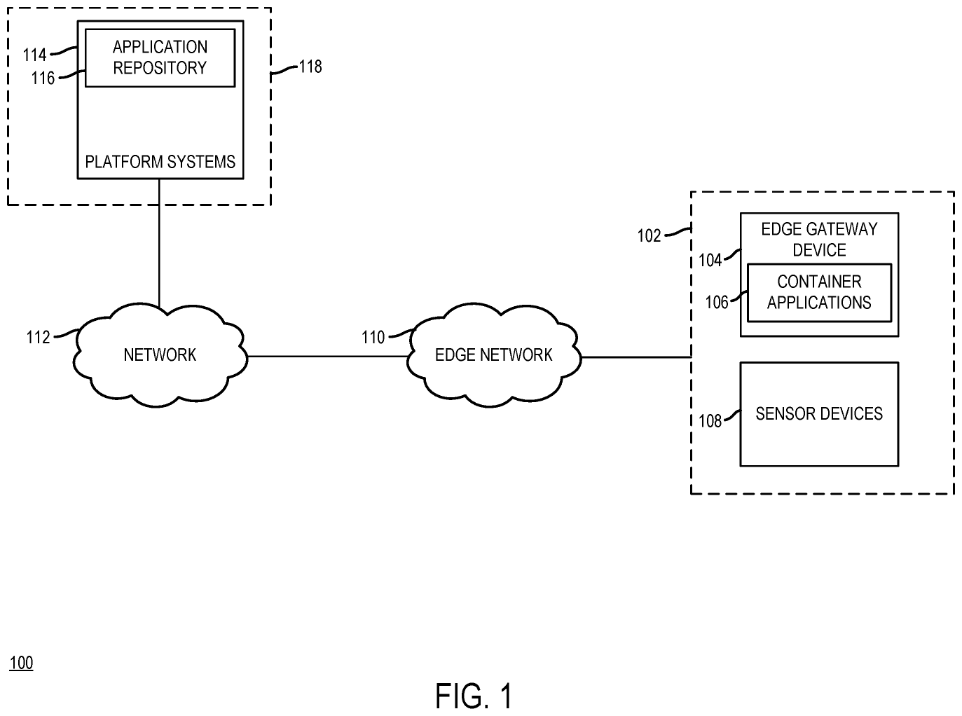

FIG. 1 illustrates a computing environment 100 in which the IoT platform may operate, according to an example embodiment. As shown, the computing environment 100 includes an apparatus 102 and one or more platform systems 114, each connected to one another via one or more networks, such as an edge network 110 and a network 112.

The apparatus 102 may be any object or entity at which the IoT platform operates. For example, the apparatus 102 may be a vehicle of a fleet. As another example, the apparatus 102 may be an industrial HVAC (Heating Ventilation and Air Conditioning) system. As yet another example, the apparatus 102 may be an enterprise security system. Of course, one of skill in the art will recognize that embodiments may be adapted to a variety of apparatuses, including industrial equipment, medical equipment, financial computing systems, mining equipment, construction equipment, buildings, etc.

The apparatus 102 may incorporate the IoT platform, for example, using an edge gateway device 104 and sensors 108. The edge gateway device 104 may be embodied as any hardware, software, and/or circuitry that serves as a hub for discretized IoT services—container applications 106—for the platform. The sensors 108 may be embodied as any hardware, software, and/or circuitry that collects data from a variety of sources. For example, in the case of a vehicle, sensors 108 may pertain to speed sensors, camera equipment, accelerometers, radar equipment, etc. The one or more platform systems 114 provide backend IoT services for the edge gateway device 104. The platform systems 114 may also include an application repository 116 to store container-based applications for retrieval by the edge gateway device 104. In some embodiments, the application repository 116 may provide the container-based applications to a user under an application store model. In an embodiment, the platform systems 114 may be physical computing systems (e.g. desktop computers, workstations, computer systems in a data center) or virtual computing instances executing via a cloud provider service 118. System data (e.g., collected by sensors 108 or other equipment) may be processed within the edge gateway device 104 itself or sent to the backend (e.g., one of the platform systems 114 of the cloud provider service 118) for processing. For example, more resource-intensive processes (e.g., video data processing) or processes that rely on tracking may be sent to the backend, while other processes can be performed locally.

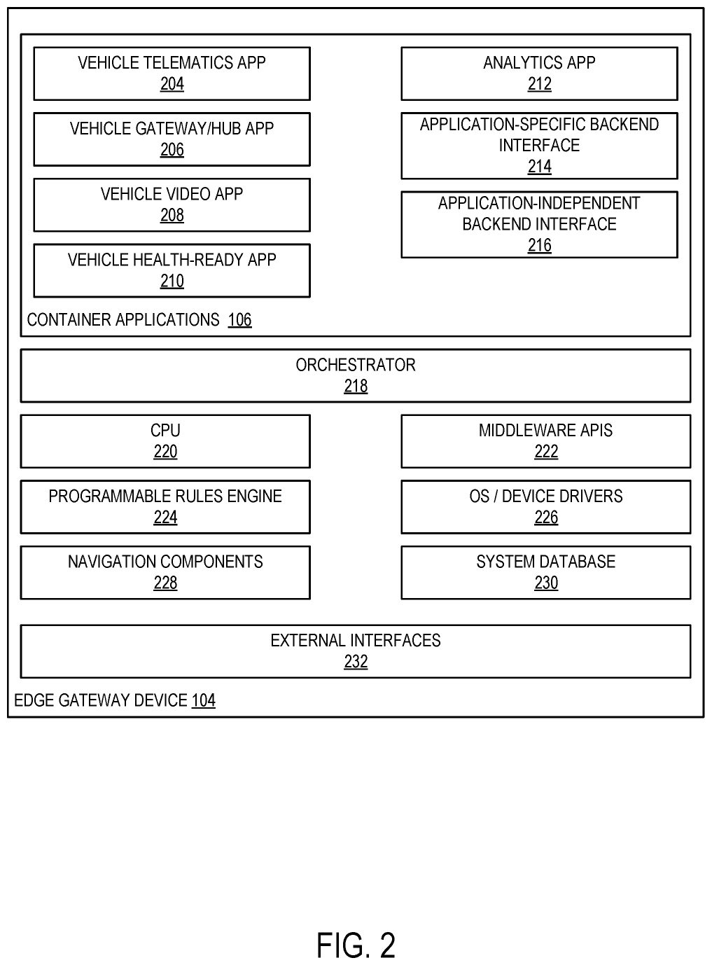

The container applications 106 comprise one or more applications each configured to perform a discrete function on the platform on behalf of the underlying medium, e.g., for a vehicles system. Particularly, each container application 106 may correspond to a standalone executable package of software that includes code, runtime, system tools, system libraries, and configuration settings that enables the application 106 to run on a device, such as the edge gateway device 104. In this example, the container applications 106 includes a vehicle telematics app 204 to perform telematics functions, a vehicle gateway/hub app 206 to manage communications between the container applications 106 therein and devices within the vehicle, a vehicle video app 208 to manage camera and video sensor functions of the vehicle, a vehicle health-ready app 210 to manage status of on-board components of the vehicle, and an analytics app 212 to evaluate data output from the various container applications 106. The listed applications in FIG. 2 are just some of the possible applications that can be created and are custom tailored to the specific industry or application on which the system is used. The container applications 106 also include backend interfaces used for communicating with backend components of the platform 118, sensor devices 108, and edge gateway device 104. For example, the container applications 106 may include an application-specific backend interface 214 to perform backend communications with the aforementioned components as pertaining to at least one of the container applications 106. The container applications 106 may also include an application-independent backend interface 216 that executes backend communications independent of the other container applications 106. In an embodiment, the container applications 106 may be Docker-based applications.

In an embodiment, the orchestrator 218 may be embodied as any hardware, software, and/or circuitry for coordinating operation of one or more the container applications 106, e.g., to collectively perform a workload. The orchestrator 218 may also communicate with hardware of the edge gateway device 104 to allocate, deallocate, or reallocate physical and logical resources within the edge gateway device 104 to perform the workload, e.g., such that certain tasks are performed within a given period of time. For instance, the orchestrator 218 may do in response to receiving telemetry data relating to performance conditions (e.g., latency, throughout, etc.). Further, the orchestrator 218 may communicate with the programmable rules engine 224 to determine instances in which operations are to be performed in communication with an edge network or primarily locally.

The CPU 220 retrieves and executes program code stored in memory. The CPU 220 may be embodied as one or more processors, each processor being a type capable of performing the functions described herein. For example, the CPU 220 may be embodied as a single or multi-core processor(s), a graphics processor, a microcontroller, or other processor or processing/controlling circuit. In some embodiments, the CPU 220 may be embodied as, include, or be coupled to a field programmable gate array (FPGA), an application-specific integrated circuit (ASIC), reconfigurable hardware or hardware circuitry, or other specialized hardware to facilitate performance of the functions described herein.

The middleware APIs 222 may be embodied as one or more software-based callable functions or services that provide an abstraction layer used to communicate with components within the IoT platform (e.g., the edge gateway device 104, sensors 108, etc.), such as container applications 106, device drivers 226, sensors 108, navigation components 228, and the like, in isolation from those components. Using the high-level functions and services of the middleware APIs 222, a user may develop or program platform applications or rules without needing to understand the underlying low-level functions, e.g., to control I/O components and devices, instantiate processing cores, define conditions to execute one or more container applications 106, etc.

The middleware APIs 222 provide high-level functions accessible by a developer user for the IoT platform in creating platform applications that communicate with the underlying apparatus, system drivers, sensors 106, and system database. In doing so, the middleware APIs mitigate or eliminate the need for application developers to write low-level code to communicate with these elements. Further, the combination of middleware APIs and control management in the system database provides a layer of isolation from these underlying elements as well, which reduces risk in human error for inadvertently corrupting or otherwise damaging any element.

The programmable rules engine 224 may be embodied as any hardware, software, and/or circuitry used to execute predefined (e.g., by the user) locally closed loop behavior of components within the edge gateway device 104. The rules may be based on a set of primitives and identify predefined triggers to invoke one or more functions from the middleware APIs 222. More particularly, the programmable rules engine 224 is configurable by a user to specify rules, trigger conditions, and actions based on a set of primitive values which specify certain closed loop behaviors to be undertaken by the edge gateway device 104. For instance, the programmable rules engine may enable a user to create new behaviors or automate relatively mundane tasks without changes to application code or to device firmware. By positioning the programmable rules engine 224 within the edge gateway device 104 rather than on a backend system over a network, the user may create locally closed loop behavior and ensure a reliable connection. In an embodiment, the programmable rules engine may be implemented through Node-RED.

The OS and device drivers 226 control and manage software and hardware components within the edge gateway device 104 (e.g., file management, memory management, I/O management, etc.). The OS and device drivers 226 may be in communication with the various components of the edge gateway device 104, such as the orchestrator 218, to coordinate the performance of workloads in operation.

The navigation components 228 may be embodied as any hardware, software, and/or circuitry to assist the edge gateway device 104 in performing geolocation and navigation-based tasks. For instance, the navigation components 228 may include a Global Navigation Satellite System (GNSS), accelerometer, and the like.

The system database 230 may be embodied as any hardware, software, and/or circuitry for storing platform-related data, such as configuration data, time-series data, video capture data, and so on, in real-time. The system database 230 may store such data as managed objects for retrieval and usage by any of the container applications 106. Further, in an embodiment, some of the managed objects may correspond to controls or parameters for other components within the system, such as I/O. To access status information or enable certain controls associated with those objects, the application may make middleware API calls targeted at those objects.

The external interfaces 232 may include interfaces that enable communication between devices and a host controller. For example, the external interfaces 232 may include CAN FD (Controller Area Network Flexible Data-Rate) interfaces, Ethernet interfaces, serial interfaces, Universal Serial Bus (USB) interfaces, I/O interfaces, network interfaces, sensor interfaces, and so on.

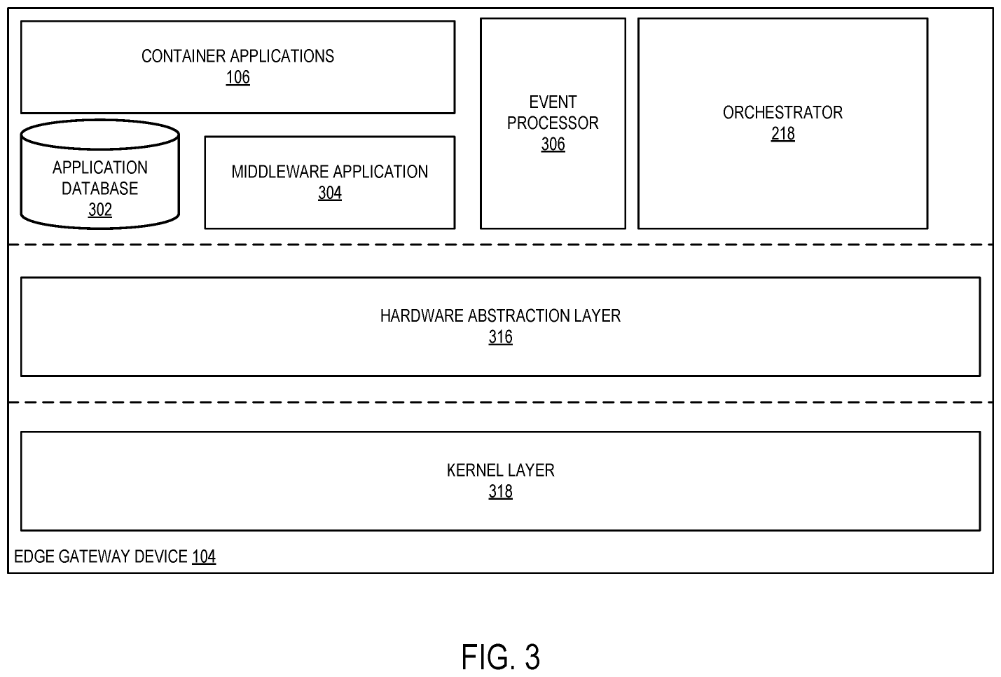

Referring now to FIG. 3, a block diagram further illustrating software layers of the edge gateway device 104 are shown. Illustratively, edge gateway device 104 may be separated into three layers, a user space layer, a hardware abstraction layer 316, and a kernel layer 318.

Illustratively, the user space layer includes the container applications 106, an application database 302, a middleware application 304, an event processor 306, and the orchestrator 218. The application database 302 is a local storage repository for container application images. By locally storing container applications not in use, a user may install the applications on-demand without needing to access the application repository 114 over the network 112. The middleware application 304 may provide a user interface to allow access to middleware APIs to enable a user to develop custom applications and rules for the edge gateway device 104. The event processor 306 may retrieve sensor data and data from container applications 106 corresponding to predefined events or rule conditions and forward such information to other components of the edge gateway device 104, such as the programmable rules engine 224.

The hardware abstraction layer 316 allows software components and modules to communicate with hardware components of the edge gateway device 104. The hardware abstraction layer 316 may abstract communications for wireless communication components (e.g., cellular, WiFi, Bluetooth), navigation components, external interfaces, video camera equipment, and the like. The kernel layer 318 serves as an interface between the hardware components and processes of the edge gateway device 104. The kernel layer 318 may include drivers for hardware components of the edge gateway device 104, such as network interface components, I/O interface components, and other hardware components. The middleware application 304 may expose the middleware APIs 222 to the user to allow the user to program applications and rules to control hardware through the hardware abstraction layer 316 and the kernel layer 318.

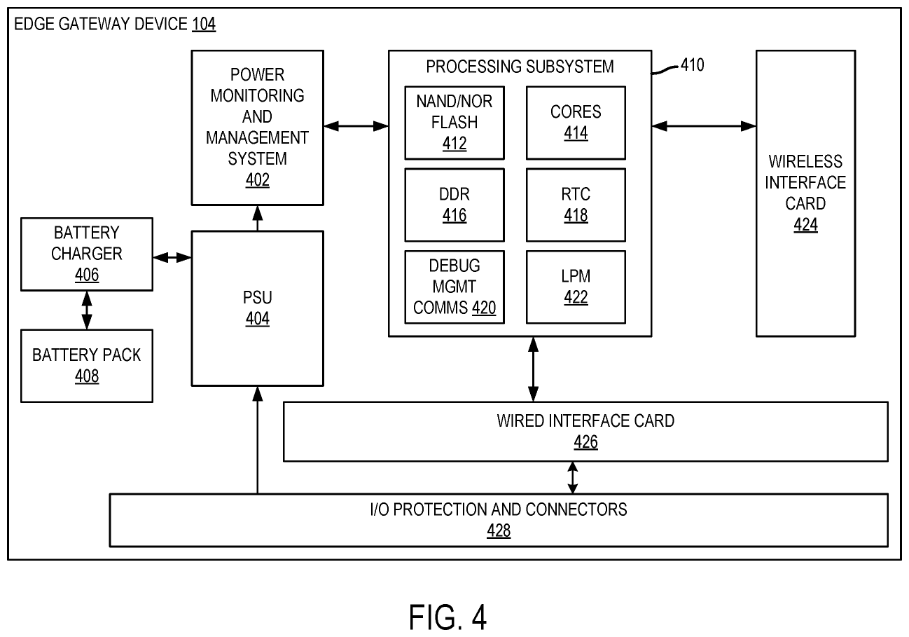

Referring now to FIG. 4, a block diagram illustrating further hardware components of the edge gateway device 104 is shown. Illustratively, the hardware components may include a power monitoring and management system 402, a power supply unit (PSU) 404, a battery charger 406, a battery pack 408, a processing subsystem 410, a wireless interface card 424, a wired interface card 426, and I/O protection and connectors 428. The PSU 404 is coupled with the power monitoring and management system 402 and the battery charger 406, which is capable of transmitting power to the battery pack 408 and the PSU 404. The power monitoring and management system 402 receives power from the PSU 404 and manages power distribution to the processing subsystem 410 and other components of the edge gateway device 104. As shown, the processing subsystem 410 includes NAND/NOR FLASH memory 412, processing cores 414, DDR memory 416, a real-time clock (RTC) 418, debug management communications 420, and LPM 422. Of course, other components, such as field-programmable gate arrays (FPGA) may be incorporated within the IoT platform (e.g., within the edge gateway device 104) to accelerate and/or perform functions described herein.

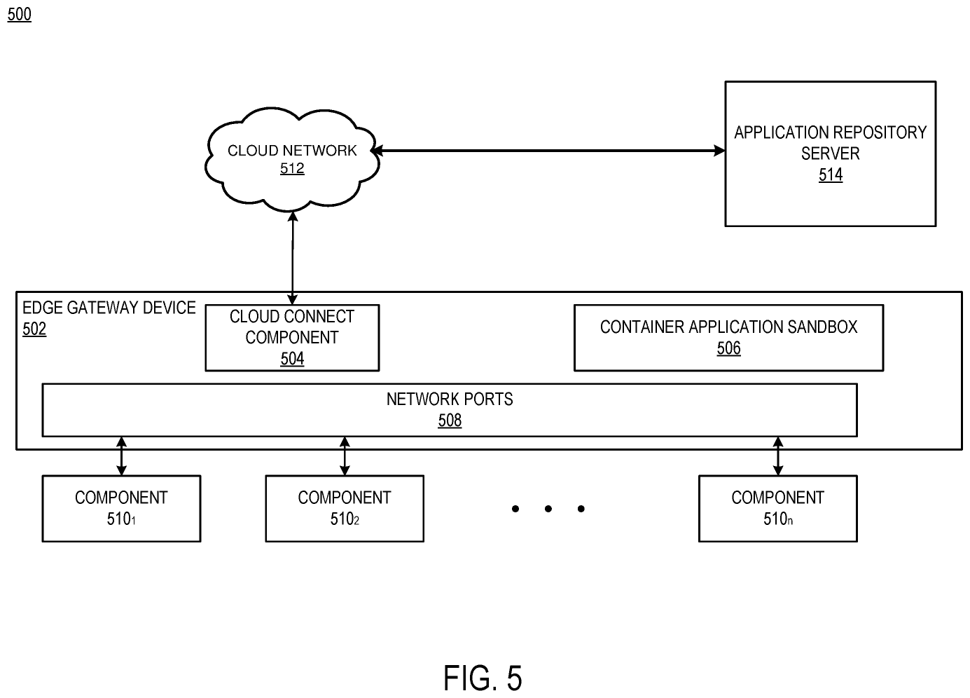

As stated, the IoT platform described herein may be adapted to a number of settings, including vehicle and transportation, industrial and automation, oil and gas, agricultural farming, construction and mining, healthcare, finance, enterprise, communications, and so on. Referring now to FIG. 5, another example of the IoT platform adapted to a vehicle telematics scenario is shown in an environment 500. Illustratively, the environment 500 includes an edge gateway device 502. The edge gateway device 502 includes a cloud connect component 504 which communicates externally with, e.g., an application repository server 514 via a cloud network 512. The edge gateway device 502 further includes a container application sandbox 506, which executes container applications such as diagnostic applications, prognostic applications, and other customized applications. The edge gateway device 502 further exposes network ports 508, which can connect to various components of the vehicle, such as components 510₁₋ₐ. The network ports 508 may leverage newer wired and wireless interfaces, such as CAN-FD, Auto Ethernet, Wi-Fi 6/6e, and Industrial Ethernet. Of course, to provide smooth migration, the network ports 508 may also support legacy interfaces, such as a CAN, GPIOs, and BLE 5.2. The components 510₁₋ₙ may relate to external hardware components connected to the edge gateway device 502, such as vehicular CAN or telematics equipment. Of course, the edge gateway device 502 may also incorporate some or all of the components previously described relative to the edge gateway device 104.

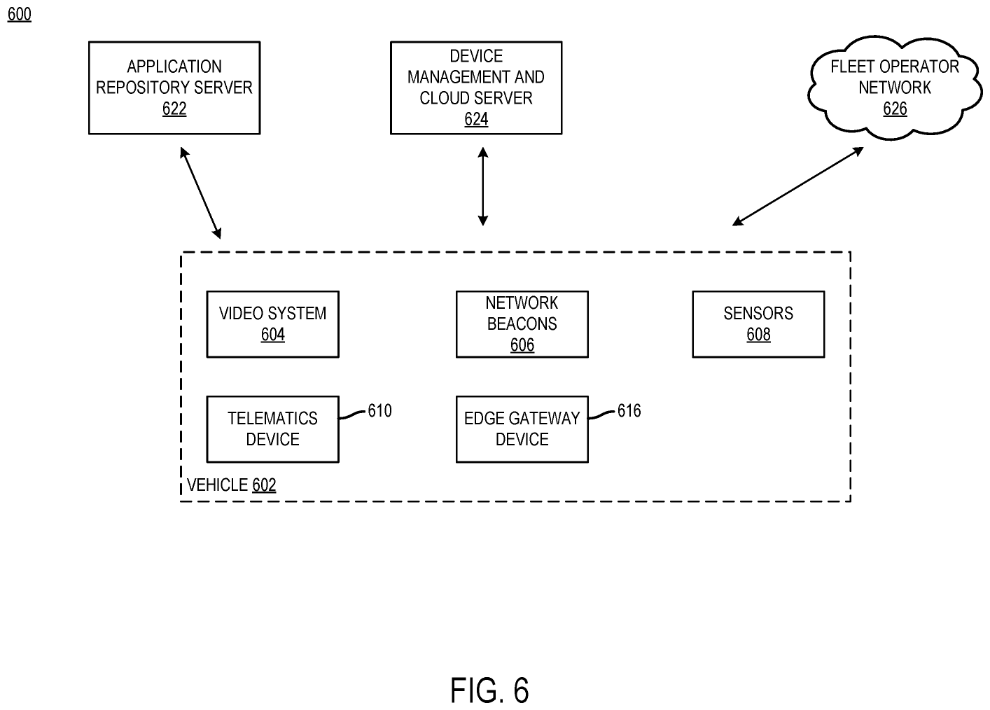

Referring now to FIG. 6, yet another example of the IoT platform adapted to a vehicle setting is shown within an environment 600. In this example, the IoT platform is adapted for a smart commercial heavy duty vehicle 602. Illustratively, the IoT platform in the environment 600 includes the core components discussed throughout the present disclosure, including the gateway device and sensors (here expressed as edge gateway device 616 and sensors 608). The vehicle 602 further includes a telematics device 610 for capturing vehicle telematics data and communicating that data to the edge gateway device 616. The edge gateway device 616 may further communicate with an application repository server 622, a device management and cloud server 624, and a fleet operator network 626. The IoT platform may leverage optional components as well, including a video system 604, network beacons 606, and other equipment not shown (e.g., energy harvesting equipment, battery equipment, and modules for intelligent logistics, cargo utilization, and cargo monitoring). In such a use case, the telematics equipment may run on a cellular connection, while the gateway device connects to telematics via a wireless or wired interface.

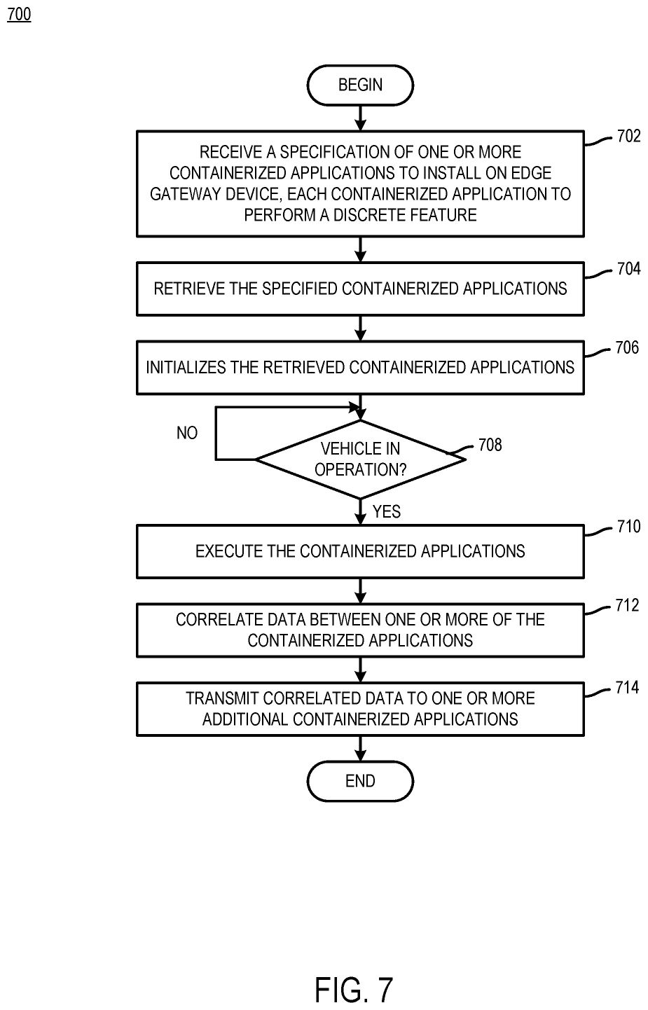

Referring now to FIG. 7, the edge gateway device 104, in operation, may perform a method 700 for managing containerized applications therewithin, according to an embodiment. As shown, the method 700 begins in block 702, in which the edge gateway device 104 receives a specification of one or more containerized applications to install thereon. For example, the edge gateway device 104 may receive such a specification in the event that a user provisions a vehicle with the IoT platform and installs the edge gateway device 104 within a vehicle.

In block 704, the edge gateway device 104 retrieves the specified containerized applications. In an embodiment, the edge gateway device 104 may determine whether the containerized application is locally available, e.g., in a local storage location within the device 104 or an external storage. If unavailable locally, the edge gateway device 104 may download the specified applications from the application repository 116.

In block 706, the edge gateway device 104 initializes the retrieved containerized applications such that the applications execute when the vehicle is in operation. In block 708, the edge gateway device 104 determines whether the vehicle is in operation (e.g., the key is inserted into the vehicle ignition). If so, then the method 700 proceeds to block 710 (otherwise, the method 700 loops back to block 708). In block 710, the edge gateway device 104 executes the containerized applications. In block 712, the edge gateway device 104 correlates data between one or more of the containerized applications in execution. In block 714, the edge gateway device 104 transmits the correlated data to one or more of the containerized applications that may use the correlated data for various purposes. For example, the correlated data may be transmitted to a container application for data analytics.

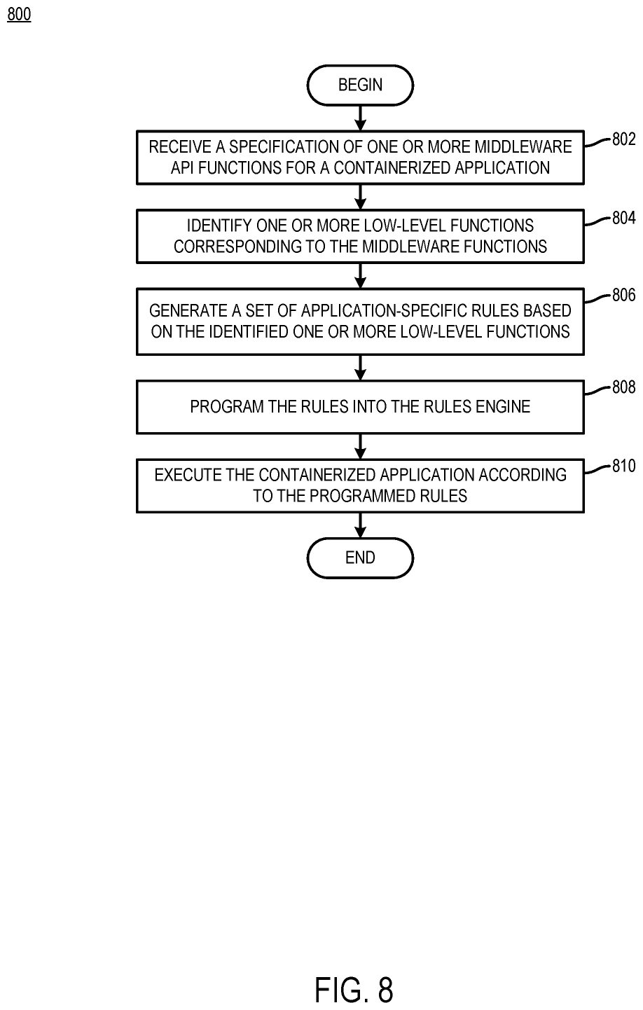

Referring now to FIG. 8, the edge gateway device 104, in operation, performs a method 800 for programming customizable rules to a rules engine therewithin, according to an embodiment. As shown, the method 800 begins in block 802, in which the edge gateway device 104 receives a specification of one or more middleware API functions for one of the containerized applications executing on the edge gateway device 104. In block 804, the edge gateway device 104 identifies one or more low-level functions corresponding to each of the middleware API functions. In block 806, the edge gateway device 104 generates a set of application-specific rules based on the identified one or more low-level functions. In block 808, the edge gateway device 104 programs the rules into the rules engine. In block 810, the edge gateway device 104 executes the containerized application according to the programmed rules.

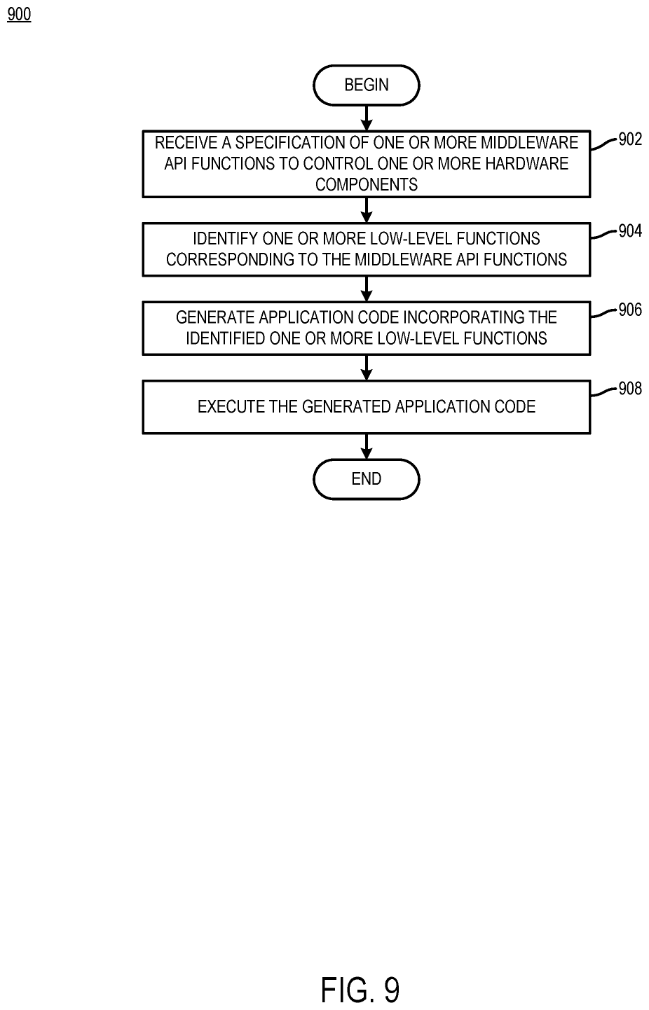

Referring now to FIG. 9, the edge gateway device 104, in operation, performs a method 900 for controlling functions within an IoT platform based on a set of middleware functions. As shown, the method 900 begins in block 902, in which the edge gateway device 104 receives a specification of one or more middleware API functions to control one or more hardware components thereon. In block 904, the edge gateway device 104 identifies one or more low-level functions corresponding to the middleware API functions. In block 906, the edge gateway device 104 generates application code incorporating the one or more low-level functions. In block 908, the edge gateway device 908 executes the generated application code.

For the purposes of promoting an understanding of the principles of the present disclosure, references are made herein to preferred embodiments and specific language is used to describe the same. It will nevertheless be understood that no limitation of the scope of the disclosure if thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

Another aspect of the present disclosure is a system. The system can be implemented in hardware, software, firmware, or combinations of hardware, software and/or firmware. In some examples, the system and methods described in this specification may be implemented using a non-transitory computer readable medium storing computer executable instructions that when executed by one or more processors of a computer cause the computer to perform operations.

Another aspect of the present disclosure provides all that is described and illustrated herein.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

Various features of the invention have been particularly shown and described in connection with the illustrative embodiment of the invention, however, it must be understood that these particular arrangements may merely illustrate, and that the invention is to be given its fullest interpretation within the terms of the appended claims.

### EXAMPLES

Illustrative examples of the technologies disclosed herein are provided below. An embodiment of the technologies may include any one or more, and any combination of, the examples described below.

Example 1 includes an apparatus comprising an edge gateway device comprising one or more processors; and a memory storing program code, which, when executed by the one or more processors, causes the edge gateway device to execute one or more container-based applications of an Internet of Things (IoT) platform, wherein the container-based applications each perform a service associated with the IoT platform.

Example 2 includes the subject matter of Example 1, and wherein the program code, when executed by the one or more processors, further causes the edge gateway device to retrieve, from a repository hosted on a cloud network, one or more additional container-based applications.

Example 3 includes the subject matter of any of Examples 1 and 2, and wherein the apparatus is a vehicle.

Example 4 includes the subject matter of any of Examples 1-3, and wherein the one or more container-based applications include functionalities for at least one of vehicle telematics, vehicle health-readiness, or vehicle video capture.

Example 5 includes the subject matter of any of Examples 1-4, and wherein the program code, when executed by the one or more processors, further causes the edge device to correlate data between the one or more container-based applications; and transmit the correlated data to a second one or more container-based applications.

Example 6 includes the subject matter of any of Examples 1-5, and wherein the edge gateway device further comprises a programmable rules engine.

Example 7 includes the subject matter of any of Examples 1-6, and wherein the program code, when executed by the one or more processors, further causes the edge gateway device to receive a specification of one or more middleware functions for one of the one or more container-based applications; identify one or more low-level functions corresponding to the one or more middleware functions; generate, from the identified one or more low-level functions, a set of rules to associate with the one of the one or more container-based applications; and load the rules into the programmable rules engine.

Example 8 includes the subject matter of any of Examples 1-7, and wherein the program code, when executed by the one or more processors, further causes the edge gateway device to receive a specification of one or more middleware functions for controlling one or more hardware components of the edge gateway device; identify one or more low-level functions corresponding to the middleware functions; generate application code incorporating the identified one or more low-level functions; and execute the generated application code.

Example 9 includes an edge gateway device comprising one or more processors; and a memory storing program code, which, when executed by the one or more processors, causes the edge gateway device to execute one or more container-based applications of an Internet of Things (IoT) platform, wherein the container-based applications each perform a service associated with the IoT platform.

Example 10 includes the subject matter of Example 9, and wherein the program code, when executed by the one or more processors, further causes the edge gateway device to retrieve, from a repository hosted on a cloud network, one or more additional container-based applications.

Example 11 includes the subject matter of any of Examples 9 and 10, and wherein the one or more container-based applications include functionalities for at least one of vehicle telematics, vehicle health-readiness, or vehicle video capture.

Example 12 includes the subject matter of any of Examples 9-11, and wherein the program code, when executed by the one or more processors, further causes the edge device to correlate data between the one or more container-based applications; and transmit the correlated data to a second one or more container-based applications.

Example 13 includes the subject matter of any of Examples 9-12, and wherein the edge gateway device further comprises a programmable rules engine.

Example 14 includes the subject matter of any of Examples 9-13, and wherein the program code, when executed by the one or more processors, further causes the edge gateway device to receive a specification of one or more middleware functions for one of the one or more container-based applications; identify one or more low-level functions corresponding to the one or more middleware functions; generate, from the identified one or more low-level functions, a set of rules to associate with the one of the one or more container-based applications; and load the rules into the programmable rules engine.

Example 15 includes the subject matter of any of Examples 9-14, and wherein the program code, when executed by the one or more processors, further causes the edge gateway device to receive a specification of one or more middleware functions for controlling one or more hardware components of the edge gateway device; identify one or more low-level functions corresponding to the middleware functions; generate application code incorporating the identified one or more low-level functions; and execute the generated application code.

Example 16 includes a computer-implemented method, comprising executing, by operation of one or more processors and on an edge gateway device, one or more container-based applications of an Internet of Things (IoT) platform, wherein the container-based applications each perform a service associated with the IoT platform.

Example 17 includes the subject matter of Example 16, and further including correlating data between the one or more container-based applications; and transmitting the correlated data to a second one or more container-based applications.

Example 18 includes the subject matter of any of Examples 16 and 17, and further including receiving a specification of one or more middleware functions for one of the one or more container-based applications; identifying one or more low-level functions corresponding to the one or more middleware functions; generating, from the identified one or more low-level functions, a set of rules to associate with the one of the one or more container-base applications; and loading the rules into a programmable rules engine of the edge gateway device.

Example 19 includes the subject matter of any of Examples 16-18, and further including receiving a specification of one or more middleware functions for controlling one or more hardware components of the edge gateway device; identifying one or more low-level functions corresponding to the middleware functions; generating application code incorporating the identified one or more low-level functions; and executing the generated application code.

Example 20 includes the subject matter of any of Examples 16-19, and wherein the one or more container-based applications include functionalities for at least one of vehicle telematics, vehicle health-readiness, or vehicle video capture.

1. An apparatus comprising:
an edge gateway device comprising:
one or more processors; and
a memory storing program code, which, when executed by the one or more processors, causes the edge gateway device to:
execute one or more container-based applications of an Internet of Things (IoT) platform, wherein the container-based applications each perform a service associated with the IoT platform.

2. The apparatus of claim 1, wherein the program code, when executed by the one or more processors, further causes the edge gateway device to:
retrieve, from a repository hosted on a cloud network, one or more additional container-based applications.

3. The apparatus of claim 1, wherein the apparatus is a vehicle.

4. The apparatus of claim 3, wherein the one or more container-based applications include functionalities for at least one of vehicle telematics, vehicle health-readiness, or vehicle video capture.

5. The apparatus of claim 1, wherein the program code, when executed by the one or more processors, further causes the edge device to:
correlate data between the one or more container-based applications; and
transmit the correlated data to a second one or more container-based applications.

6. The apparatus of claim 1, wherein the edge gateway device further comprises a programmable rules engine.

7. The apparatus of claim 6, wherein the program code, when executed by the one or more processors, further causes the edge gateway device to:
receive a specification of one or more middleware functions for one of the one or more container-based applications;
identify one or more low-level functions corresponding to the one or more middleware functions;
generate, from the identified one or more low-level functions, a set of rules to associate with the one of the one or more container-based applications; and
load the rules into the programmable rules engine.

8. The apparatus of claim 1, wherein the program code, when executed by the one or more processors, further causes the edge gateway device to:
receive a specification of one or more middleware functions for controlling one or more hardware components of the edge gateway device;
identify one or more low-level functions corresponding to the middleware functions;
generate application code incorporating the identified one or more low-level functions; and
execute the generated application code.

9. An edge gateway device comprising:
one or more processors; and
a memory storing program code, which, when executed by the one or more processors, causes the edge gateway device to:
execute one or more container-based applications of an Internet of Things (IoT) platform, wherein the container-based applications each perform a service associated with the IoT platform.

10. The edge gateway device of claim 9, wherein the program code, when executed by the one or more processors, further causes the edge gateway device to:
retrieve, from a repository hosted on a cloud network, one or more additional container-based applications.

11. The edge gateway device of claim 9, wherein the one or more container-based applications include functionalities for at least one of vehicle telematics, vehicle health-readiness, or vehicle video capture.

12. The edge gateway device of claim 9, wherein the program code, when executed by the one or more processors, further causes the edge device to:
correlate data between the one or more container-based applications; and
transmit the correlated data to a second one or more container-based applications.

13. The edge gateway device of claim 9, wherein the edge gateway device further comprises a programmable rules engine.

14. The edge gateway device of claim 13, wherein the program code, when executed by the one or more processors, further causes the edge gateway device to:
receive a specification of one or more middleware functions for one of the one or more container-based applications;
identify one or more low-level functions corresponding to the one or more middleware functions;
generate, from the identified one or more low-level functions, a set of rules to associate with the one of the one or more container-based applications; and
load the rules into the programmable rules engine.

15. The edge gateway device of claim 9, wherein the program code, when executed by the one or more processors, further causes the edge gateway device to:
receive a specification of one or more middleware functions for controlling one or more hardware components of the edge gateway device;
identify one or more low-level functions corresponding to the middleware functions;
generate application code incorporating the identified one or more low-level functions; and
execute the generated application code.

16. A computer-implemented method, comprising:
executing, by operation of one or more processors and on an edge gateway device, one or more container-based applications of an Internet of Things (IoT) platform, wherein the container-based applications each perform a service associated with the IoT platform.

17. The computer-implemented method of claim 16, further comprising:
correlating data between the one or more container-based applications; and
transmitting the correlated data to a second one or more container-based applications.

18. The computer-implemented method of claim 16, further comprising:
receiving a specification of one or more middleware functions for one of the one or more container-based applications;
identifying one or more low-level functions corresponding to the one or more middleware functions;
generating, from the identified one or more low-level functions, a set of rules to associate with the one of the one or more container-base applications; and
loading the rules into a programmable rules engine of the edge gateway device.

19. The computer-implemented method of claim 16, further comprising:
receiving a specification of one or more middleware functions for controlling one or more hardware components of the edge gateway device;
identifying one or more low-level functions corresponding to the middleware functions;
generating application code incorporating the identified one or more low-level functions; and
executing the generated application code.

20. The computer-implemented method of claim 16, wherein the one or more container-based applications include functionalities for at least one of vehicle telematics, vehicle health-readiness, or vehicle video capture.
